(19) United States
(12) Patent Application Publication
(10) Pub. No.: US 2017/0206619 A1
(43) Pub. Date: Jul. 20, 2017

(54) METHOD FOR MANAGING VIOLATION INCIDENT INFORMATION AND VIOLATION INCIDENT MANAGEMENT SYSTEM AND COMPUTER-READABLE RECORDING MEDIUM

(71) Applicant: KOREA INTERNET & SECURITY AGENCY, Seoul (KR)

(72) Inventors: Hyei Sun Cho, Seoul (KR); Seul Gi Lee, Seoul (KR); Nak Hyun Kim, Seoul (KR); Byung Ik Kim, Seoul (KR); Tai Jin Lee, Seoul (KR)

(21) Appl. No.: 15/006,708

(22) Filed: Jan. 26, 2016

(30) Foreign Application Priority Data
Jan. 19, 2016 (KR) 10-2016-0006477

(51) Int. Cl. G06Q 50/26; H04L 29/06

(52) U.S. Cl. CPC G06Q 50/265; H04L 63/1425

(57) ABSTRACT

Provided is a mechanism capable of assigning at least one index (ID) to violation abuse resources, violation association information, and violation information by taking into consideration organic relationships between the violation abuse resources, the violation association information, and the violation information when the generated violation abuse resources, the violation association information, and the violation information are collected through an external violation sharing channel or when they are collected or queried and of managing the generated violation abuse resources, the violation association information, and the violation information.

### CROSS REFERENCE TO RELATED APPLICATION

The present application claims the benefit of Korean Patent Application No. 10-2016-0006477 filed in the Korean Intellectual Property Office on Jan. 19, 2016, the entire contents of which are incorporated herein by reference.

### BACKGROUND OF THE INVENTION

1. Technical Field

Embodiments relate to a technology for managing violation incidents, which is required to integrate and analyze violation incidents in network communication.

2. Description of the Related Art

In general, a violation incident refers to a behavior that generates damage, such as the leak of information and the paralysis of service, using a malicious method, such as hacking, viruses, or the infection of malware. An object of a violation incident tends to achieve a social chaos and a political purpose other than a simple behavior, such as personal showing off and a monetary purpose.

An attacker who has such a specific object is characterized in that he or she continues to open an attack in order to achieve his or her object.

In order to solve such a problem, techniques for detecting, collecting, and analyzing violation incidents are being developed. There are various methods for detecting and analyzing a violation incident, such as a method for analyzing a host infected with malware or tracking the behavior of a hacker through traffic and log analysis of a network or an analysis method based on the reputations of several vaccine companies and users.

However, there is a problem in that the analysis of a single violation incident does not support the analysis of an association with another violation incident, a target type attack based on the check of the characteristics of the same attacker, and the prediction of the future attack because it does not organically connect one violation incident and the other violation incident.

Pieces of violation incident information generating a violation incident are very various and frequently generated, but there is a problem in that it is difficult to analyze a violation incident because organic collection and management between pieces of violation incident information are insufficient.

### PRIOR ART DOCUMENT

### Patent Document

Korean Patent Application Publication No. 2015-0081889 (Jul. 15, 2015)

### SUMMARY OF THE INVENTION

Embodiments relate to the provision of a method, violation incident management system, and a computer-readable recording medium for analyzing, classifying, and managing a relationship between pieces of violation incident information based on a violation incident shared channel sharing violation incident information.

In accordance with an embodiment, a method for managing violation abuse information in order to systematically manage violation incident information collected through a violation incident management system installed in a business and an organization network and required to analyze a violation incident includes collecting violation abuse resources and attached violation association information associated with the respective violation abuse resources from at least one violation sharing channel and generating violation information recursively classified from the collected violation association information; storing the collected violation abuse resources, the violation association information, and the violation information in a database; and assigning at least one index (ID) to the violation abuse resources, the violation association information, and the violation information by taking into consideration organic relationships between the violation abuse resource, the violation association information, and the violation information when collecting or querying the violation abuse resources, the violation association information, and the violation information and storing the at least one index in the database.

Assigning the at least one index and storing the at least one index in the database may include assigning a first index to each type when collecting the violation abuse resources for each type and assigning a second index, that is, a query task unit, when querying the violation association information matched up with each type of the violation abuse resource to which the first index has been assigned.

Assigning the at least one index and storing the at least one index in the database may further include increasing a third index assigned whenever the violation association information is recursively queried or whenever the violation information is queried.

Assigning the at least one index and storing the at least one index in the database may further include storing history information generated for each collected violation abuse resource when collecting the violation abuse resources in the database and assigning a fourth index to each of the pieces of history information stored in the database.

Assigning the at least one index and storing the at least one index in the database may include searching the database for a collection target for violation association information when querying the violation association information stored in the database or newly collecting the violation association information, extracting a corresponding violation abuse resource from the database if, as a result of the search, the collection target is found to be present, determining whether the first index has been assigned to the extracted violation abuse resource, and assigning the previous first index to the extracted violation abuse resource if, as a result of the determination, it is determined that the first index has been assigned to the extracted violation abuse resource and assigning a new first index to the extracted violation abuse resource if, as a result of the determination, it is determined that the first index has not been assigned to the extracted violation abuse resource.

Assigning the at least one index and storing the at least one index in the database may further include determining whether a second index for violation association information matched up with the extracted violation abuse resource is present within a set time if the previous first index has been assigned to the extracted violation abuse resource and generating history information about the extracted violation abuse resource if, as a result of the determination, it is determined that the second index for the violation association information is present and assigning a new second index to the violation association information if, as a result of the determination, it is determined that the second index for the violation association information is not present.

In accordance with an embodiment, a violation incident management system installed in a business and an organization network and configured to systematically manage violation incident information required to analyze a violation incident includes a data collection module configured to collect violation abuse resources and attached violation association information associated with the respective violation abuse resources from at least one violation sharing channel and to generate violation information recursively classified from the collected violation association information; a database configured to store the collected violation abuse resources, the violation association information, and the violation information; and a data management module configured to assign at least one index (ID) to the violation abuse resources, the violation association information, and the violation information by taking into consideration organic relationships between the violation abuse resource, the violation association information, and the violation information when collecting or querying the violation abuse resources, the violation association information, and the violation information and storing the at least one index in the database.

The data management module may include a violation resource management module configured to assign a first index to each type when collecting the violation abuse resources for each type and an association information management module configured to assign a second index, that is, a query task unit, when querying the violation association information matched up with each type of the violation abuse resource to which the first index has been assigned.

The data management module may further include a recursive query management module configured to increase a third index assigned whenever the violation association information is recursively queried or whenever the violation information is queried.

The data management module may further include a history management module configured to generate history information for each collected violation abuse resource when collecting the violation abuse resources, assign a fourth index to each of the pieces of history information, and store the pieces of history information in the database.

The violation resource management module may include a collection target check module configured to search the database for a collection target for violation association information when querying the violation association information stored in the database or newly collecting the violation association information, a violation resource extraction module configured to extract a corresponding violation abuse resource from the database if, as a result of the search, the collection target is found to be present, and a first index determination module configured to determine whether the first index has been assigned to the extracted violation abuse resource.

The first index determination module may assign the previous first index to the extracted violation abuse resource if, as a result of the determination, it is determined that the first index has been assigned to the extracted violation abuse resource and may assign a new first index to the extracted violation abuse resource if, as a result of the determination, it is determined that the first index has not been assigned to the extracted violation abuse resource.

The violation resource management module may further include a second index determination module configured to determine whether a second index for violation association information matched up with the extracted violation abuse resource is present within a set time if the previous first index has been assigned to the extracted violation abuse resource.

The second index determination module may generate history information about the extracted violation abuse resource if, as a result of the determination, it is determined that the second index for the violation association information is present and may assign a new second index to the violation association information if, as a result of the determination, it is determined that the second index for the violation association information is not present

As described above, an embodiment can propose the directivity of intelligent analyses for the future violation incident by analyzing violation associations through the management of violation incident information and classifying and systematically managing the violation associations.

Accordingly, an embodiment can expect the role of a datawarehouse capable of sharing and querying data when an expected violation incident is generated by continuously accumulating and managing violation incident histories.

Advantages of the following embodiments are not limited to the aforementioned advantages, and various other advantages may be evidently understood by those skilled in the art to which the embodiments pertain from the following description.

### BRIEF DESCRIPTION OF THE DRAWINGS

The accompanying drawings are provided to help understanding of the following embodiments and provide the embodiments along with the detailed description. However, the technical characteristics of the embodiments are not restricted by a specific drawing, and the characteristics disclosed in the drawings may be combined to form new embodiments.

FIG. 1 is a flowchart illustrating an example of a method for managing violation abuse information according to an embodiment.

FIG. 2 is a block diagram illustrating an example of a violation incident management system for performing the method for managing violation abuse information shown in FIG. 1.

FIG. 3 is a diagram showing an example of a collection scenario for recursive classification, which is disclosed at step 210 of FIG. 1.

FIG. 4 is a diagram showing a process for obtaining associated violation information through recursive queries, which is disclosed in FIG. 1.

FIG. 5 is a diagram showing the type of collection of RBL file information, which is disclosed in FIG. 1.

FIG. 6 is a flowchart illustrating a detailed example of a method for assigning indexes, which is disclosed at step 230 of FIG. 1.

FIG. 7 is a flowchart illustrating an example of a procedure for issuing indexes, which is disclosed in FIGS. 1 and 6.

FIG. 8 is a flowchart illustrating another example of the procedure for issuing indexes, which is disclosed in FIG. 7.

FIG. 9 is a block diagram illustrating an example of a violation incident management system according to an embodiment.

FIG. 10 is a block diagram showing a detailed configuration of a data management module of FIG. 9.

FIG. 11 is a block diagram illustrating the configuration of a violation resource management module of FIG. 10.

### DETAILED DESCRIPTION

Hereinafter, exemplary embodiments disclosed in this specification are described in detail with reference to the accompanying drawings. The same or similar elements are assigned the same or similar reference numerals regardless of their reference numerals, and redundant descriptions thereof are omitted.

Furthermore, in describing the exemplary embodiments disclosed in this specification, a detailed description of the known technologies will be omitted if it is deemed to make the gist of the present invention unnecessarily vague.

Furthermore, terms including ordinal numbers, such as “the first” and “the second”, may be used to describe various elements, but the elements are not restricted by the terms. The terms are used to only “distinguish” one element from the other element.

Furthermore, it should be understood that “and/or” disclosed in the following embodiments includes a specific and all possible combinations of one or more of related enumerated items.

Furthermore, it is to be understood that the accompanying drawings are intended to make easily understood the exemplary embodiments disclosed in this specification and the technical spirit disclosed in this specification is not restricted by the accompanying drawings and that the exemplary embodiments include all modifications, equivalents, and substitutions which fall within the spirit and technical scope of the present invention.

Furthermore, unless explicitly described to the contrary, a term “comprise (or include or have)” disclosed in the following embodiments will be understood to imply the inclusion of a stated element but not the exclusion of any other elements.

Furthermore, violation incident information disclosed in the entire specification should be understood as a word having a wider concept, including pieces of information queried, generated, and processed by a violation incident management system in addition to pieces of information collected through a violation sharing channel.

Hereinafter, an aspect of a method and system for managing violation incident information is described in more detail.

<Example of Method for Managing Violation Abuse Information>

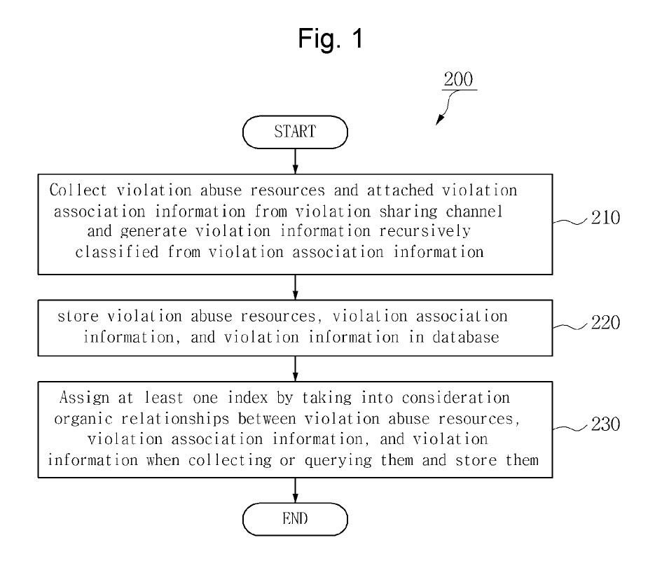

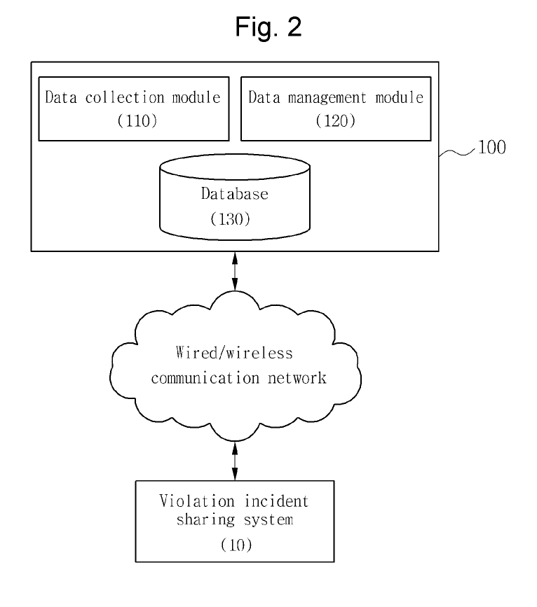

FIG. 1 is a flowchart illustrating an example of a method for managing violation abuse information according to an embodiment, and FIG. 2 is a block diagram illustrating an example of a violation incident management system for performing the method for managing violation abuse information shown in FIG. 1.

The violation incident management system 100 of FIG. may include a data collection module 110 for collecting and/or querying violation resources and/or data, such as violation association information, from at least one violation sharing channel, a data management module 120 for assigning indexes to data collected and/or queried by the data collection module 110 and managing the indexes, and assigning indexes to corresponding data when the corresponding data is queried and managing the indexes, and a database 130 for storing data processed by the data collection module 110 and the data management module 120.

The violation sharing channel is a site or information providing channel operated by an external violation incident sharing system 10, and may include a first information sharing channel and a second information sharing channel.

The external violation incident sharing system 10 and the violation incident management system 100 may be connected over a wired communication network or a wireless communication network.

The method for managing violation abuse information, which is performed by the violation incident management system 100 of FIG. 2, is described below.

Referring to FIG. 1, the method 200 for managing violation abuse information according to an embodiment may include step 210 to step 230 in order for the violation incident management system 100 to systematically manage violation incident information required to analyze collected violation incidents.

First, at illustrative step 210, the data collection module 110 may collect violation abuse resources and pieces of attached violation association information, associated with the respective violation abuse resources, from at least one violation sharing channel.

For example, the data collection module 110 may automatically access the external violation incident sharing system 10 and may collect violation incident-related information (e.g., violation abuse resources) from the first information sharing channel, including a cyber black box (e.g., a violation resource providing site) provided by the external violation incident sharing system 10.

The first information sharing channel may be a cyber black box, C-share, DNSBL, or a distribution place/malware sharing channel (e.g., virusshare.com), but the present invention is not limited to the first information sharing channel.

In contrast, the at least one violation abuse resource may include domain information, IP information, hash information, and e-mail information misused for a violation attack. The violation abuse resources may be indicative of information collected from the at least one first information sharing channels.

Furthermore, in order to obtain more detailed and associated information about violation abuse resources through the second information sharing channel, the data collection module 110 may access the second information sharing channel of the external violation incident sharing system 10 and collect violation association information from the second information sharing channel as the results of a query about each of the violation abuse resources.

The second information sharing channel may include DNS/PTR records, Whois, IP2Location, Google violation incident history, a second level domain (SLD), a file analysis system, a malware similarity analysis system, SPEED, and a top level domain (TLD).

In contrast, the collected violation association information may be information which has an association for each violation abuse resource, that is, an investigation target, and which has been subdivided, including domain information, IP information, hash information, and e-mail information misused for a violation attack.

Furthermore, at illustrative step 210, the data collection module 110 may generate violation information obtained by recursively classifying the collected violation association information again.

The generated violation information may be indicative of information classified so that the collected violation association information is recursively returned to the violation abuse resources.

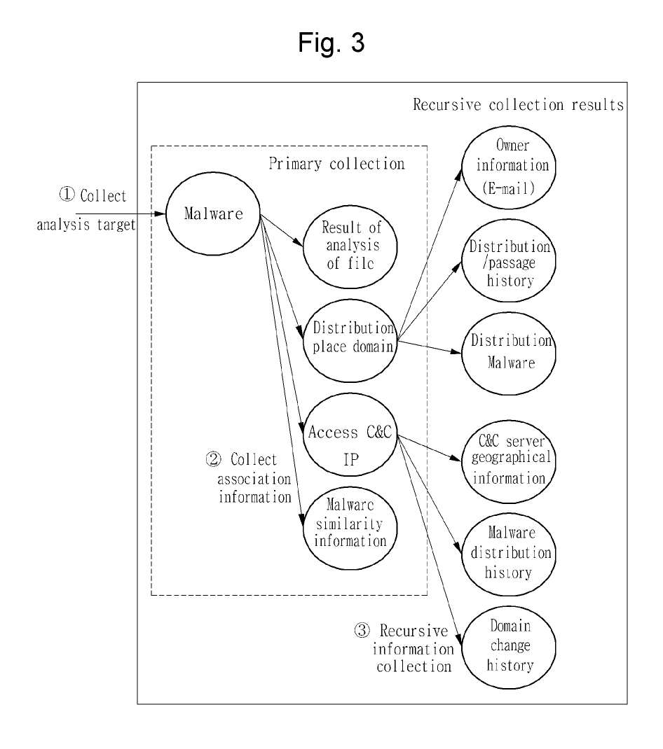

Such recursive classification may be a measure for analyzing an additional violation incident association structure for major resources (e.g., IP, domain, and hash) that belong to the violation association information and that is used for an attack. A detailed example of the recursive classification may be shown as in FIG. 3.

FIG. 3 is a diagram showing an example of a collection scenario for the recursive classification, which is disclosed at step 210 of FIG. 1.

Referring to FIG. 3, the collection scenario for the recursive classification according to an embodiment may collect the violation abuse resources of malware through the first information sharing channel and may collect a distribution place domain, an access IP, and malware similarity information, that is, attached information about the violation abuse resources, as the results of file analysis of the malware, through the second information sharing channel.

For example, if violation association information about the distribution place domain is recursively classified, owner information (e-mail information) and distribution place/passage information related to the violation association information of the results of file analysis may be classified. Furthermore, distributed malware related to the violation abuse resources of the malware may be classified. As a result, the original violation abuse resources may be found out.

Likewise, if the access IP and the malware similarity information are recursively classified, the original violation abuse resources having high similarity may be found out. In this case, the found original violation abuse resources are named returned violation information.

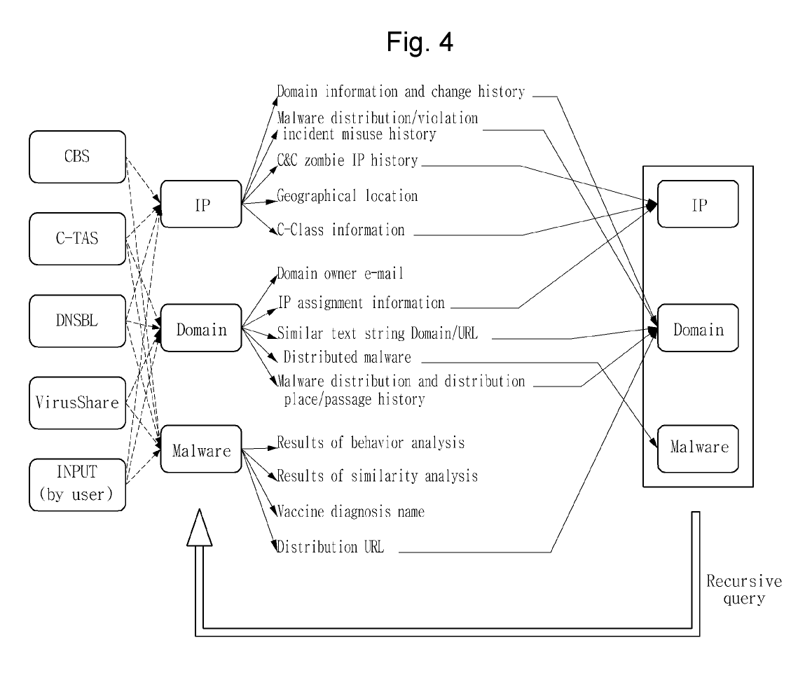

Relationships between the violation information returned to the original violation abuse resources, the violation abuse resources, and the violation association information may be shown as in FIG. 4.

FIG. 4 is a diagram showing the process for obtaining associated violation information through recursive queries, which is disclosed in FIG. 1. In FIG. 4, the violation abuse resources of an IP is classified into violation association information, such as a domain change information and change history, a malware distribution/violation incident abuse history, and a geographical location. The domain change information and change history, malware distribution/violation incident abuse history, and geographical location are recursively classified into IP information and domain information, that is, the original violation abuse resources.

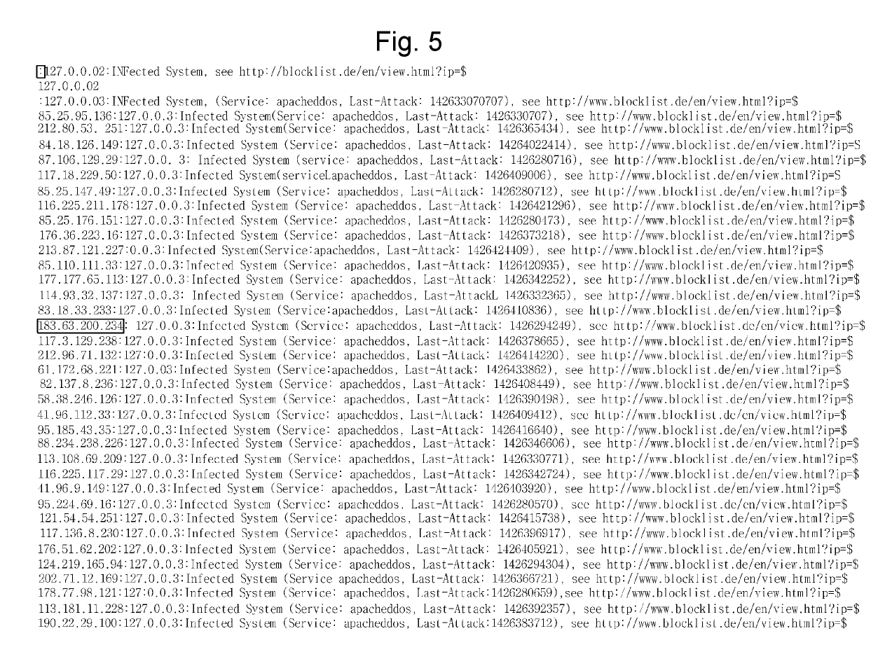

An example of RBL file information of blacklist information may be shown as in Table 1. The type of collected RBL file information may be collected as in FIG. 5.

TABLE 1

| ITEMS | CONTENTS |
|---|---|
| Type | ssh, mail, apache, imap, ftp, |
| | sip, bots, strongips, ircbot, |
| | bruteforcelogin |
| Collection cycle | 10 min. |
| File size | About 200 KB~5 MB |
| Number of processing lines | About 22,000 |
| RBL parser | block,ist.jar |
| RBL file | all.list |
| Element type | IP |
| Download type | wget |

Referring back to FIG. 1, at illustrative step 220, the database 130 may store pieces of information processed or collected and queried at step 210, for example, violation abuse resources, violation association information and/or violation information.

The database 130 is a concept including a computer-readable recording medium, and refers to a database of a wide meaning including data recording based on a file system in addition to a database of a narrow meaning. The database 130 is included in the category of the database described in the present invention if data is extracted by searching the database for only a set of simple logs.

At illustrative step 230, the data management module 120 may assign at least one index (ID) by taking into consideration organic relationships between violation abuse resources, violation association information, and violation information when collecting or querying the violation abuse resources, the violation association information and/or the violation information stored in the database 130 and store them.

For example, whenever the data collection module 110 collects violation abuse resources, the data management module 120 may assign a unique index (ID) to each of the violation abuse resources. When the data collection module 110 collects violation association information and/or whenever the data collection module 110 queries violation association information stored in the database 130, the data management module 120 may assign a unique index (ID) to each of pieces of the violation association information.

Furthermore, the data management module 120 may assign an index when generating or collecting violation abuse resources, violation association information and/or violation information or when querying at least one of a violation abuse resource, violation association information and/or violation information.

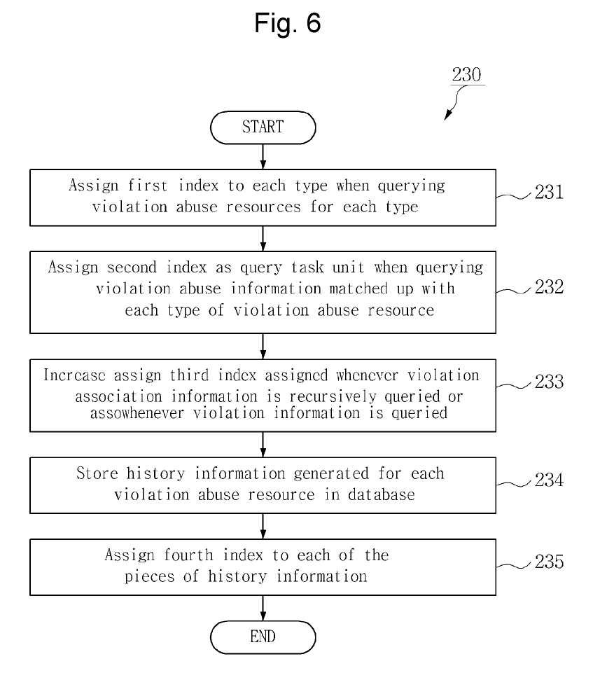

A more detailed example of a method for assigning indexes is described below with reference to FIGS. 6 to 8.

<Example of Method for Assigning Indexes>

FIG. 6 is a flowchart illustrating a detailed example of the method for assigning indexes, which is disclosed at step 230 of FIG. 1.

Referring to FIG. 6, step 230 according to an embodiment may include step 231 to step 235 in order to efficiently manage indexes.

First, at illustrative step 231, the data management module 120 may detect types of violation abuse resources stored in the database 130, for example, a domain type, IP type, hash type, and e-mail type and assign a first index (e.g., R_ID or Resource ID) to each of the detected types in order to efficiently manage the violation abuse resources.

At illustrative step 232, the data management module 120 may assign a second index (e.g., Job ID or a violation association information query ID), that is, a query task unit, to each of pieces of queried violation association information when violation association information matched up with the type of violation abuse resource to which the first index has been assigned is queried from the database 130.

The assignment of the second index may have a meaning as one unit for analyzing an intelligent violation incident. The second index is always managed along with the type of violation abuse resource when the violation abuse resource is managed, so the type of each violation abuse resource may be determined through a corresponding second index.

At illustrative step 233, the data management module 120 may assign a third index to violation information whenever the violation information recursively classified from the violation association information stored in the database 130 is generated.

Accordingly, the data management module 120 may increase the third index whenever querying the violation information to which the third index has been assigned or whenever recursively querying the violation association information.

The third index may be indicative of a recursive query level. The reason why the third index is increased is that the third index may be used to generate a graph for analyzing an intelligent violation incident and may be usefully used to check a relationship (i.e., the degree of closeness) between the third index and the violation abuse resource.

Targets that require the aforementioned recursive query may be shows as in Table 2.

TABLE 2

| Primary | | Secondary | | | |
|---|---|---|---|---|---|
| query | | query | Whether ID | Recursive | |
| type | Channel | type | is managed | query | Ground |
| Domain | DNS | Domain | Management | X | Not queried because it |
| | | | | | is ns |
| | | IP | Management | ◯ | Queried because it is |
| | | | | | IP actually connected |
| | | | | | to current domain |
| | Whois | Domain | Management | X | Not queried because it |
| | | | | | is ns |
| | | Domain | Management | X | Not queried because it |
| | | | | | is ns |
| | | IP | Management | X | Not queried because it |
| | | | | | is ns |
| | | IP | Management | X | Not queried because it |
| | | | | | is ns |
| | Malwares.com | IP | Management | ◯ | Queried because it is |
| | | | | | IP connected to past |
| | | | | | domain |
| | | Domain | Management | ◯ | Queried because it is |
| | | | | | past malicious URL |
| | | | | | using corresponding |
| | | | | | domain |
| | | Domain | Management | X | Association |
| | | | | | information is not |
| | | | | | queried because it is |
| | | | | | past malicious URL |
| | | | | | using corresponding |
| | | | | | domain |
| | | Hash | Management | ◯ | Queried because it is |
| | | | | | malware sample |
| | | | | | downloaded from |
| | | | | | corresponding domain |
| | | Hash | Management | X | Association |
| | | | | | information is not |
| | | | | | queried because it is |
| | | | | | normal file sample |
| | | | | | downloaded from |
| | | | | | corresponding domain |
| | | Hash | Management | ◯ | Queried because it is |
| | | | | | malware sample |
| | | | | | communicating with |
| | | | | | corresponding domain |
| | | Hash | Management | X | Association |
| | | | | | information is not |
| | | | | | queried because it is |
| | | | | | normal file |
| | | | | | communicating with |
| | | | | | corresponding domain |
| IP | PTR | Domain | Management | X | Not queried because it |
| | | | | | is ns |
| | | Domain | Management | ◯ | Queried because it is |
| | | | | | IP actually connected |
| | | | | | to current domain |
| | Malwares.com | Domain | Management | ◯ | Queried because it is |
| | | | | | domain address |
| | | | | | connected to past |
| | | | | | domain |
| | | Domain | Management | ◯ | Queried because it is |
| | | | | | past malicious URL |
| | | | | | using corresponding IP |
| | | Domain | Management | X | Association |
| | | | | | information is not |
| | | | | | queried because it is |
| | | | | | past malicious URL |
| | | | | | using corresponding |
| | | | | | IP |
| | | Hash | Management | ◯ | Queried because it is |
| | | | | | malware sample |
| | | | | | downloaded from |
| | | | | | corresponding IP |
| | | Hash | Management | X | Association |
| | | | | | information is not |
| | | | | | queried because it is |
| | | | | | normal file sample |
| | | | | | downloaded from |
| | | | | | corresponding IP |
| | | Hash | Management | ◯ | Queried because it is |
| | | | | | malware sample |
| | | | | | communicating with |
| | | | | | corresponding IP |
| | | Hash | Management | X | Association |
| | | | | | information is not |
| | | | | | queried because it is |
| | | | | | normal file |
| | | | | | communicating with |
| | | | | | corresponding IP |
| Hash | Malwares.com | IP | Management | ◯ | Queried because it |
| | | | | | induces user to access |
| | | | | | modified IP and |
| | | | | | malicious behavior is |
| | | | | | performed |
| | | IP | Management | ◯ | Association |
| | | | | | information is queried |
| | | | | | because it is |
| | | | | | communicated external |
| | | | | | IP |
| | | Domain | Management | ◯ | Association |
| | | | | | information is queried |
| | | | | | because it is URL from |
| | | | | | which corresponding |
| | | | | | file has been |
| | | | | | distributed |
| | CuckooSandbox | Hash | Management | ◯ | Malware additionally |
| | | | | | derived from malicious |
| | | | | | file, association |
| | | | | | information needs to |
| | | | | | be queried |
| | | IP | Management | ◯ | src IP according to |
| | | | | | malicious file |
| | | IP | Management | ◯ | dst IP according to |
| | | | | | malicious file |

In Table 2, the primary query type may means an example of the type of each violation abuse resource, and the secondary query type may mean an example of violation association information matched up with the type of each violation abuse resource.

In this case, it is necessary to manage an index assigned to each of pieces of violation association information. The recursive query target is indicated by “O.”

In this case, corresponding violation association information may be recursively queried based on the recursive query target indicated by “O.”

At illustrative step 234, when collecting violation abuse resources through the first information sharing channel, the data management module 120 may generate history information corresponding to each of the collected violation abuse resources and store the generated history information in the database 130.

The generation of the history information may be usefully used to check which external target (e.g., CBS or Cshare) has made an analysis request using which resources (or value) when.

At illustrative step 235, the data management module 120 may assign a fourth index to each of the pieces of history information stored in the database 130 in order to help the check of the aforementioned analysis request.

The assignment of the index may be stored in the database 130 in a table form.

As described above, in the present embodiment, an intelligent analysis of the future violation incident can be smoothly performed because an index is generated when corresponding violation abuse information is collected, queried, or generated.

<Example of Procedure for Issuing Indexes>

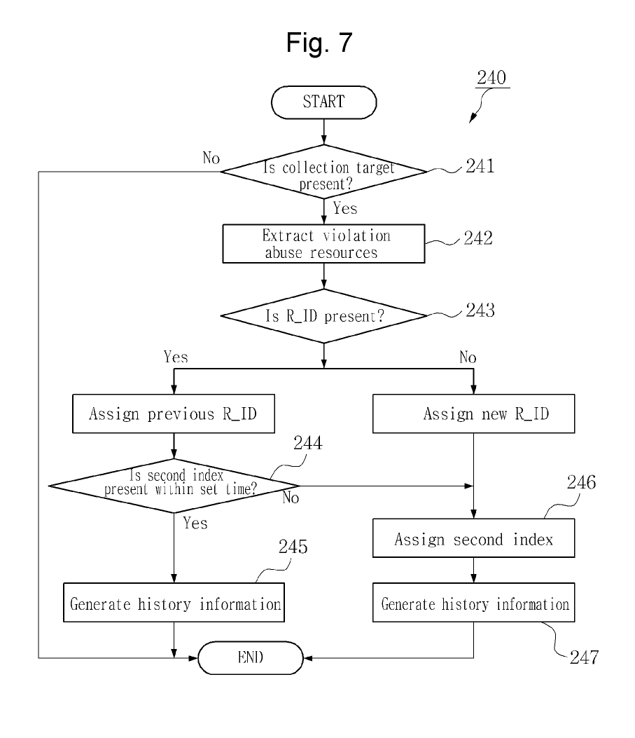

FIG. 7 is a flowchart illustrating an example of the procedure for issuing indexes, which is disclosed in FIGS. 1 and 6.

Referring to FIG. 7, the procedure for issuing indexes according to an embodiment may include step 241 to step 247.

First, at illustrative step 241, the data management module 120 may search the database 130 for a collection target (e.g., a violation abuse resource) for violation association information when querying or newly collecting the violation association information stored in the database 130.

For example, if, as a result of the search, the collection target, for example, a corresponding violation abuse resource is found to be present, the data management module 120 may extract the corresponding violation abuse resource from the database 130 at step 242.

If, as a result of the search, the collection target, for example, a corresponding violation abuse resource is found to be not present, the data management module 120 may terminate its processor.

At illustrative step 243, the data management module 120 may determine whether a first index (e.g., R_ID) has been assigned to the violation abuse resource extracted from the database 130 or whether the first index (e.g., R_ID) is present in the extracted violation abuse resource.

For example, if, as a result of the determination at step 243, it is determined that the first index has been assigned to the violation abuse resource, the data management module 120 may assign the previous first index (e.g., previous R_ID) to the extracted violation abuse resource. If, as a result of the determination at step 243, it is determined that the first index has not been assigned to the violation abuse resource, the data management module 120 may assign a new first index (e.g., new R_ID) to the extracted violation abuse resource.

For example, if the previous first index has been assigned, the data management module 120 may determine whether a second index (e.g., JOB ID) assigned to violation association information matched up with the violation abuse resource extracted from the database 130 is present within a set time at step 244.

For example, if, as a result of the determination at step 244, it is determined that the second index assigned to the violation association information is present, the data management module 120 may generate history information about the extracted violation abuse resource at step 245. If, as a result of the determination at step 244, it is determined that the second index assigned to the violation association information is not present, the data management module 120 may assign a new second index (i.e., new JOB ID) to the determined violation association information at step 246 and may generate history information about the violation abuse resource to which the new first index has been assigned at step 247.

As described above, in the present embodiment, a violation incident can be easily analyzed using an index because a new index is assigned to violation abuse information and/or violation association information whenever the violation abuse information and/or the violation association information is queried or collected. Furthermore, the index can be used as data capable of active responses when a violation incident is generated.

<Example of Procedure for Issuing Indexes>

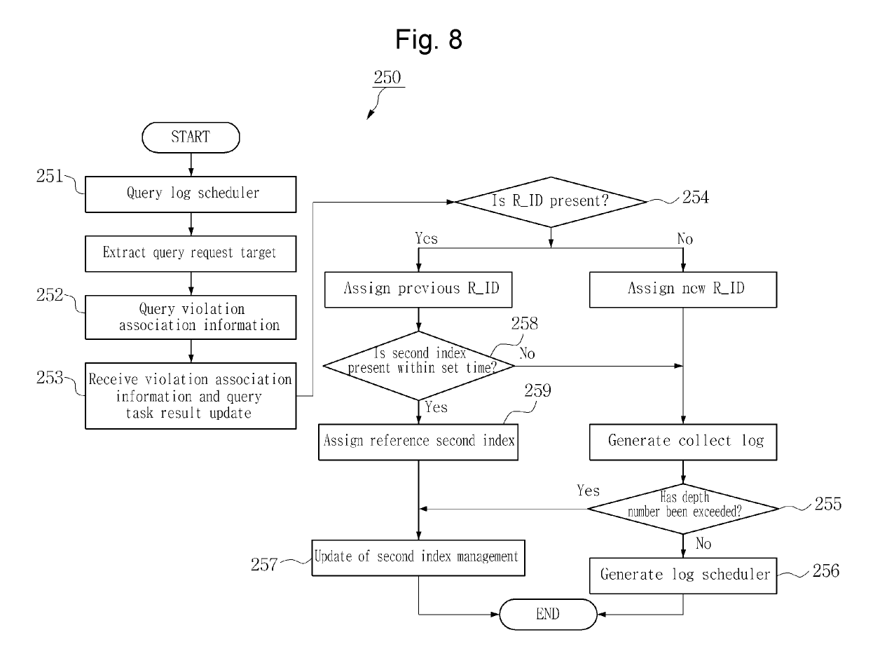

FIG. 8 is a flowchart illustrating another example of the procedure for issuing indexes, which is disclosed in FIG. 7.

Referring to FIG. 8, the procedure 250 for issuing indexes according to an embodiment may include step 251 to step 259.

First, at illustrative step 251, the data management module 120 may extract a violation abuse resource, that is, the query request target of a log scheduler, from the database 130.

At illustrative step 252, the data management module 120 may access a violation sharing channel, for example, the second information sharing channel using the extracted violation abuse resource and query whether violation association information corresponding to the extracted violation abuse resource is present.

For example, if, as a result of the query, the violation association information matched up with the extracted violation abuse resource is found to be present, the data management module 120 may receive the violation association information and store it in the database 130 so that a query task result is updated at step 253.

At illustrative step 254, the data management module 120 may determine whether a first index (e.g., R_ID) has been assigned to the violation abuse resource updated as a result of the query of the violation association information.

For example, if, as a result of the determination at step 254, it is determined that the first index has been assigned to the updated violation abuse resource, the data management module 120 may assign the previous first index to the extracted violation abuse resource. If, as a result of the determination at step 254, it is determined that the first index has not been assigned to the updated violation abuse resource, the data management module 120 may assign a new first index to the extracted violation abuse resource.

For example, after assigning the new first index and generating a selection log (collect log), the data management module 120 may determine whether the generated selection log exceeds a set recursive query (or depth) number at step 255.

For example, if, as a result of the determination at step 255, it is determined that the selection log does not exceed the set recursive query (or depth) number, the data management module 120 may generate a corresponding log scheduler at step 256. If, as a result of the determination at step 255, it is determined that the selection log exceeds the set recursive query (or depth) number, the data management module 120 may perform the update of second index management at step 257.

For example, if the previous first index has been assigned at step 254, the data management module 120 may determine whether a second index assigned to the violation association information matched up with the violation abuse resource extracted from the database 130 is present within a set time at step 258.

For example, if, as a result of the determination at step 258, it is determined that the second index assigned to the violation association information is present within the set time, the data management module 120 may assign a reference index (e.g., ref_Job_ID) instead of the previous second index at step 259 and performs the update of second index management at step 257.

If, as a result of the determination at step 258, it is determined that the second index assigned to the violation association information is not present within the set time, the data management module 120 may perform the process for generating a selection log.

As described above, in the present embodiment, a violation incident can be conveniently analyzed using an index because a new index is assigned to violation abuse information and/or violation association information or association information is recursively queried when the violation abuse information and/or the violation association information is queried. Furthermore, the index can be used as data capable of active responses when a violation incident is generated.

<Example of Violation Incident Management System>

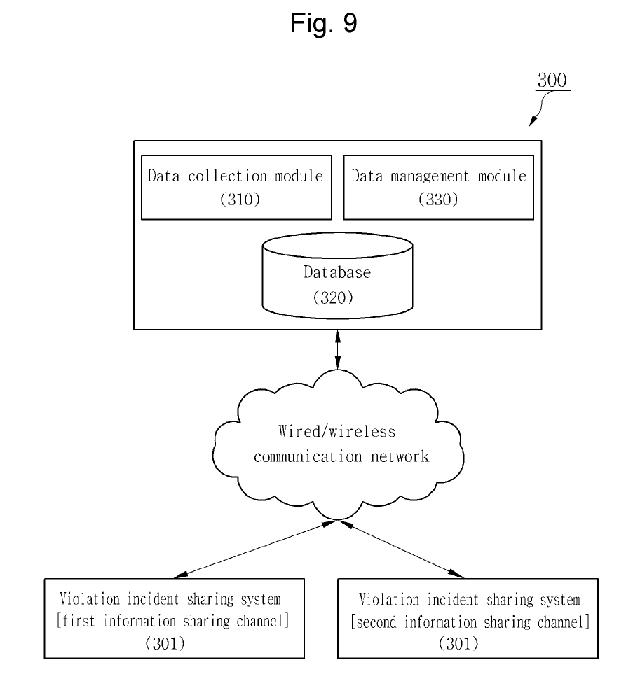

FIG. 9 is a block diagram illustrating an example of a violation incident management system according to an embodiment.

Referring to FIG. 9, the violation incident management system 300 according to an embodiment may include a data collection module 310, a database 320, and a data management module 330 in order to systematically manage violation incident information required to analyze a violation incident.

The violation incident management system 300 may be connected to an external violation incident sharing system 301 over a wired communication network or a wireless communication network.

First, the data collection module 310 may collect violation abuse resources and pieces of attached violation association information, associated with the respective violation abuse resources, from at least one violation sharing channel.

The violation sharing channel is a site or information providing channel operated by the external violation incident sharing system 301, and may include a first information sharing channel and a second information sharing channel.

For example, the data collection module 310 may automatically access the external violation incident sharing system 10 and may collect violation incident-related information (e.g., violation abuse resources) from the first information sharing channel, including a cyber black box (e.g., a violation resource providing site) provided by the external violation incident sharing system 10.

The first information sharing channel may include a cyber black box, C-share, DNSBL, or a distribution place/malware sharing channel (e.g., virusshare.com), but the present invention is not limited to the first information sharing channel.

In contrast, the at least one violation abuse resource may have a plurality of pieces of type information, including domain information, IP information, hash information, and e-mail information misused for a violation attack.

For example, if the first information sharing channel is a cyber black box placed in each organization, the data collection module 310 may periodically poll the analysis request directory of the cyber black box and check whether IP information and hash file information misused for a violation incident are present.

If, as a result of the check, IP information and hash file information is found to be present in the cyber black box, the data collection module 310 may collect IP information and hash file information from the cyber black box.

For another example, if the first information sharing channel is C-share, the data collection module 310 may collect violation abuse resources, including a malware distribution place/passage, a CnC IP, an attack IP, and malware information misused for a violation incident, from C-share.

In this case, C-share maybe a violation incident information sharing system operated by the KISA.

For example, the data collection module 310 may execute Export API and may collect an XML in which an IP, a domain, and hash information misused for a violation incident have been stored from C-share in real time.

Export API is a violation incident information real-time sharing program provided by a C-share site and does not stop its API operation for real-time collection.

For another example, if the first information sharing channel is the Blacklist channel of DNSBL, the data collection module 310 may collect violation abuse resources, including blacklist IP information, RBL file information, and blacklist domain information misused for a violation incident, from the Blacklist channel of DNSBL.

In this case, the Blacklist channel of DNSBL may be a Spamcannibal, Blocklist, Dnsbh, Uceprotect, or Wpbl site.

For example, blacklist IP information and RBL file information may be collected from the Spamcannibal, Blocklist, Uceprotect, and Wpbl sites, and blacklist IP information and blacklist domain information may be collected from Dnsbh.

The collected RBL file information may be parsed information.

For another example, if the first information sharing channel is a malware sharing channel, the data collection module 310 may check new and variety malware information and collect violation abuse resources, including hash file information, from the malware sharing channel.

More specifically, the data collection module 310 may periodically access a site which shares malware, may query new and variety malware information, and may query hash/original file information about the query new and variety malware information.

A method for obtaining new and variety malware information may include periodically accessing a sharing website, scrolling a webpage when new information is updated, and querying new and variety malware information.

For example, the data collection module 310 may periodically access the main page of virusshare.com, may check the value of “SHA256”, may terminate if the checked value is identical with the value of “SHA256” of recently collected malware (i.e., there is no change), and may collect new and variety malware information and the original from virusshare.com if the checked value is not identical with the value of “SHA256” of recently collected malware.

Furthermore, in order to obtain a more detailed and associated information about a violation abuse resource through a violation sharing channel, for example, the second information sharing channel, the data collection module 310 may access the second information sharing channel of the external violation incident sharing system 301 and collect violation association information, that is, the results of the query of each violation abuse resource, from the second information sharing channel.

In this case, the second information sharing channel may include a DNS/PTR record, Whois, IP2Location, Google violation incident history, a second level domain (SLD), a file analysis system, a malware similarity analysis system, SPEED, and a top level domain (TLD).

In contrast, the collected violation association information may be information which has an association with each of violation abuse resources, that is, a query target, including domain information, IP information, hash information, and e-mail information misused for a violation attack, and which has been subdivided.

For example, if the second information sharing channel is a DNS/PTR record, the data collection module 310 may query violation association information, including DNS record information for domain activation and PTR record information for IP activation, from a DNS/PTR record.

More specifically, in order to determine whether an IP has been activated, the data collection module 310 may execute a PTR record query, may check a domain using PTR record information, and may query NS domain information and administrator domain information from the PTR using SOA record information.

For another example, if the second information sharing channel is Whois, the data collection module 310 may query violation association information, including domestic and foreign Whois information for checking the owner of a domain, from Whois.

More specifically, in order to check information about the owner of a domain, the data collection module 310 may query domestic and foreign Whois information and query information about the e-mail account and location of the owner of an (attach or normal) domain through a corresponding process.

For another example, if the second information sharing channel is IP2Location, the data collection module 310 may query violation association information, including country code (CC) of an IP, geographical information (longitude/latitude), and ISP information, from IP2Location.

In the results of the query, the location of an IP in addition to the statistics of each country can be represented.

For another example, if the second information sharing channel is at least one of a Google violation incident history, a second level domain (SLD), a file analysis system, a malware similarity analysis system, SPEED, and a top level domain (TLD), the data collection module 310 may query violation association information, including a malware distribution history, a vaccine diagnosis name, an SLD reference similarity domain, API fetch information, static/dynamic analysis result information, malware similarity information, vaccine check information, and TLD reference similarity domain information, from at least one of the Google violation incident history, the second level domain (SLD), the file analysis system, the malware similarity analysis system, SPEED and the top level domain (TLD).

For example, the data collection module 310 may obtain a violation incident and related violation association information through the use of an API from the malwares.com site of the external violation incident sharing system 301.

In addition, the malwares.com site provides malware distribution information, the past Domain-IP mapping history, and file static/behavior analysis information.

Furthermore, the illustrative data collection module 310 may generate violation information recursively classified again from collected violation association information.

The generated violation information is indicative of information recursively classified from the collected violation association information so that the information returns to a violation abuse resource, and may be parsed information.

In an embodiment, the illustrative database 320 may store pieces of information processed or collected and queried by the data collection module 310 and the data management module 330, for example, violation abuse resources, violation association information, and/or violation information and index information.

The database 320 is a concept including a computer-readable recording medium, and refers to a database of a wide meaning including data recording based on a file system in addition to a database of a narrow meaning. The database 130 is included in the category of the database described in the present invention if data is extracted by searching the database for only a set of simple logs.

The data management module 330 may assign at least one index (ID) by taking into consideration organic relationships between violation abuse resources, violation association information, and violation information when collecting or querying the violation abuse resources, the violation association information and/or the violation information stored in the database 320.

For example, whenever the data collection module 310 collects violation abuse resources, the data management module 330 may assign a unique index (ID) to each of the violation abuse resources. When the data collection module 310 collects violation association information and/or whenever the data collection module 310 queries violation association information stored in the database 320, the data management module 330 may assign a unique index (ID) to each of pieces of the violation association information.

Furthermore, the data management module 330 may assign an index when generating or collecting violation abuse resources, violation association information and/or violation information or when querying at least one of a violation abuse resource, violation association information and/or violation information.

Hereinafter, the data management module 330 is described in more detail.

<Detailed Example of Data Management Module>

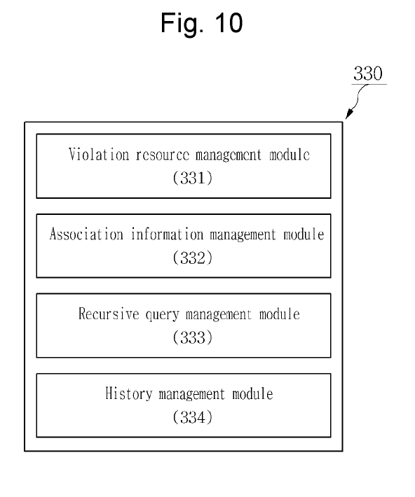

FIG. 10 is a block diagram showing a detailed configuration of the data management module 330 of FIG. 9.

Referring to FIG. 10, the data management module 330 according to an embodiment may include a violation resource management module 331, an association information management module 332, a recursive query management module 333, and a history management module 334.

The illustrative violation resource management module 331 may detect types of violation abuse resources stored in the database 320, for example, a domain type, IP type, hash type, and e-mail type and assign a first index (e.g., R_ID or Resource ID) to each of the detected types in order to efficiently manage the violation abuse resources.

The illustrative association information management module 332 may assign a second index (e.g., Job_ID or a violation association information query ID), that is, a query task unit, to each of pieces of queried violation association information when violation association information matched up with the type of violation abuse resource to which the first index has been assigned is queried from the database 320.

The assignment of the second index may have a meaning as one unit for analyzing an intelligent violation incident. The second index is always managed along with the type of violation abuse resource when the violation abuse resource is managed, so the type of each violation abuse resource may be determined through a corresponding second index.

The illustrative recursive query management module 333 may assign a third index to violation information whenever the violation information recursively classified from the violation association information stored in the database 320 is generated.

Accordingly, the recursive query management module 333 may increase the third index whenever querying the violation information to which the third index has been assigned or whenever recursively querying the violation association information.

The third index may be indicative of a recursive query level. The reason why the third index is increased is that the third index may be used to generate a graph for analyzing an intelligent violation incident and may be usefully used to check a relationship (i.e., the degree of closeness) between the third index and the violation abuse resource.

Targets that require the aforementioned recursive query may be shows as in Table 2 above.

In Table 2, the primary query type may means an example of the type of each violation abuse resource, and the secondary query type may mean an example of violation association information matched up with the type of each violation abuse resource.

In this case, it is necessary to manage an index assigned to each of pieces of violation association information. The recursive query target is indicated by “O.” In this case, corresponding violation association information may be recursively queried based on the recursive query target indicated by “O.”

When collecting violation abuse resources through the first information sharing channel, the illustrative history management module 334 may generate history information corresponding to each of the collected violation abuse resources and store the generated history information in the database 320.

The generation of the history information may be usefully used to check which external target (e.g., CBS or Cshare) has made an analysis request using which resources (or value) when.

The history management module 334 may assign a fourth index to each of the pieces of history information stored in the database 320 in order to help the check of the aforementioned analysis request.

The assignment of the index may be stored in the database 320 in a table form.

As described above, in the present embodiment, an intelligent analysis of the future violation incident can be smoothly performed because an index is generated when corresponding violation abuse information is collected, queried, or generated.

Hereinafter, the violation resource management module 331 is described in detail.

<Detailed Example of Violation Resource Management Module>

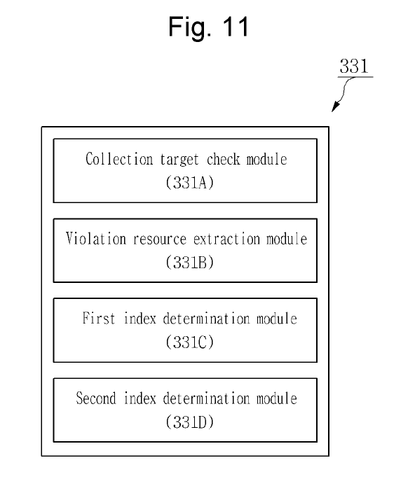

FIG. 11 is a block diagram illustrating the configuration of the violation resource management module 331 of FIG. 10.

Referring to FIG. 11, the violation resource management module 331 according to an embodiment may include a collection target check module 331A, a violation resource extraction module 331B, a first index determination module 331C, and a second index determination module 331D.

The illustrative collection target check module 331A may search the database 320 for a collection target (e.g., a violation abuse resource) for violation association information when querying or newly collecting the violation association information stored in the database 320.

For example, if, as a result of the search, the collection target, for example, a corresponding violation abuse resource is found to be present, the illustrative violation resource extraction module 331B may extract the corresponding violation abuse resource from the database 320. If, as a result of the search, the collection target, for example, a corresponding violation abuse resource is found to be not present, the illustrative violation resource extraction module 331B may terminate its processor.

The illustrative first index determination module 331C may determine whether a first index has been assigned to the violation abuse resource extracted from the database 320.

For example, if, as a result of the determination, it is determined that the first index has been assigned to the violation abuse resource within a set time, the first index determination module 331C may assign the previous first index to the extracted violation abuse resource. If, as a result of the determination, it is determined that the first index has not been assigned to the violation abuse resource within the set time, the first index determination module 331C may assign a new first index to the extracted violation abuse resource.

Finally, if the previous first index has been assigned as described above, the illustrative second index determination module 331D may determine whether a second index assigned to violation association information matched up with the violation abuse resource extracted from the database 320 is present within a set time.

For example, if, as a result of the determination, it is determined that the second index assigned to the violation association information is present, the second index determination module 331D may generate history information about the extracted violation abuse resource. If, as a result of the determination, it is determined that the second index assigned to the violation association information is not present, the second index determination module 331D may assign a new second index to the determined violation association information and may generate history information about the violation abuse resource to which the new first index has been assigned.

As described above, in the present embodiment, a violation incident can be easily analyzed using an index because a new index is assigned to violation abuse information and/or violation association information whenever the violation abuse information and/or the violation association information is queried or collected. Furthermore, the index can be used as data capable of active responses when a violation incident is generated.

The data management module 330 may further perform another procedure for issuing an index, which is disclosed in FIG. 7. The procedure for issuing an index has been described in detail with reference to FIG. 7 and is different only in a point of time, and thus a description thereof is omitted.

The aforementioned method for managing violation abuse information may be implemented in the form of program instructions which can be executed through various computer elements and may be recorded on a computer-readable recording medium.

The computer-readable recording medium may be a specific medium which can be accessed by a processor. Such a medium may include both volatile and nonvolatile media, attachable and detachable media, a communication medium, a storage medium, and a computer storage medium.

The communication medium may include computer-readable instructions, data structures, program modules, carriers, or other data of modulated data signals, such as other transmission mechanisms, and may include information transfer media of known and specific other forms.

The storage medium may include RAM, flash memory, ROM, EPROM, electrically erasable and programmable read-only memory (EEPROM), registers, hard disks, detachable disks, compact disk read-only memory (CD-ROM), or storage media of known and specific other forms.

The computer storage medium includes removable and non-removable and volatile and nonvolatile media implemented using a specific method or technology for storing computer-readable instructions, data structures, program modules, or information, such as other data.

The computer storage medium may include a hardware device specially configured to store and execute program instructions, such as RAM, ROM, EPROM, EEPROM, flash memory, other solid memory technologies, CD-ROM, DVD or other optical storage devices, magnetic cassettes, magnetic tapes, and magnetic disk storage devices.

The program code may include, for example, not only machine code produced by a compiler, but also high-level language code executable by a computer using an interpreter.

As described above, although the embodiments of the present invention have been described with reference to the accompanying drawings, those skilled in the art to which the present invention pertains will appreciate that the present invention may be implemented in other detailed forms without departing from the technical spirit or essential characteristics of the present invention. Accordingly, the aforementioned embodiments should be construed as being only illustrative from all aspects not as being restrictive.

What is claimed is:

1. A method for managing violation abuse information in order to systematically manage violation incident information collected through a violation incident management system installed in a business and an organization network and required to analyze a violation incident, the method comprising:
collecting violation abuse resources and attached violation association information associated with the respective violation abuse resources from at least one violation sharing channel and generating violation information recursively classified from the collected violation association information;
storing the collected violation abuse resources, the violation association information, and the violation information in a database; and
assigning at least one index (ID) to the violation abuse resources, the violation association information, and the violation information by taking into consideration organic relationships between the violation abuse resource, the violation association information, and the violation information when collecting or querying the violation abuse resources, the violation association information, and the violation information and storing the at least one index in the database.

2. The method of claim 1, wherein assigning the at least one index and storing the at least one index in the database comprises:
assigning a first index to each type when collecting the violation abuse resources for each type; and
assigning a second index as a query task unit when querying the violation association information matched up with each type of the violation abuse resource to which the first index has been assigned.

3. The method of claim 2, wherein assigning the at least one index and storing the at least one index in the database further comprises increasing a third index assigned whenever the violation association information is recursively queried or whenever the violation information is queried.

4. The method of claim 2, wherein assigning the at least one index and storing the at least one index in the database comprises:
storing history information generated for each collected violation abuse resource when collecting the violation abuse resources in the database; and
assigning a fourth index to each of the pieces of history information stored in the database.

5. The method of claim 2, wherein assigning the at least one index and storing the at least one index in the database comprises:
searching the database for a collection target for violation association information when querying the violation association information stored in the database or newly collecting the violation association information;
extracting a corresponding violation abuse resource from the database if, as a result of the search, the collection target is found to be present;
determining whether the first index has been assigned to the extracted violation abuse resource; and
assigning the previous first index to the extracted violation abuse resource if, as a result of the determination, it is determined that the first index has been assigned to the extracted violation abuse resource and assigning a new first index to the extracted violation abuse resource if, as a result of the determination, it is determined that the first index has not been assigned to the extracted violation abuse resource.

6. The method of claim 5, wherein assigning the at least one index and storing the at least one index in the database further comprises:
determining whether a second index for violation association information matched up with the extracted violation abuse resource is present within a set time if the previous first index has been assigned to the extracted violation abuse resource; and
generating history information about the extracted violation abuse resource if, as a result of the determination, it is determined that the second index for the violation association information is present and assigning a new second index to the violation association information if, as a result of the determination, it is determined that the second index for the violation association information is not present.

7. A violation incident management system installed in a business and an organization network and configured to systematically manage violation incident information required to analyze a violation incident, the violation incident management system comprising:
a data collection module configured to collect violation abuse resources and attached violation association information associated with the respective violation abuse resources from at least one violation sharing channel and to generate violation information recursively classified from the collected violation association information;
a database configured to store the collected violation abuse resources, the violation association information, and the violation information; and
a data management module configured to assign at least one index (ID) to the violation abuse resources, the violation association information, and the violation information by taking into consideration organic relationships between the violation abuse resource, the violation association information, and the violation information when collecting or querying the violation abuse resources, the violation association information, and the violation information and storing the at least one index in the database.

8. The violation incident management system of claim 7, wherein the data management module comprises:
a violation resource management module configured to assign a first index to each type when collecting the violation abuse resources for each type; and
an association information management module configured to assign a second index as a query task unit when querying the violation association information matched up with each type of the violation abuse resource to which the first index has been assigned.

9. The violation incident management system of claim 7, wherein the data management module further comprises a recursive query management module configured to increase a third index assigned whenever the violation association information is recursively queried or whenever the violation information is queried.

10. The violation incident management system of claim 7, wherein the data management module comprises a history management module configured to generate history information for each collected violation abuse resource when collecting the violation abuse resources, assign a fourth index to each of the pieces of history information, and store the pieces of history information in the database.

11. The violation incident management system of claim 8, wherein the violation resource management module comprises:
a collection target check module configured to search the database for a collection target for violation association information when querying the violation association information stored in the database or newly collecting the violation association information;
a violation resource extraction module configured to extract a corresponding violation abuse resource from the database if, as a result of the search, the collection target is found to be present; and
a first index determination module configured to determine whether the first index has been assigned to the extracted violation abuse resource,
wherein the first index determination module assigns the previous first index to the extracted violation abuse resource if, as a result of the determination, it is determined that the first index has been assigned to the extracted violation abuse resource and assigns a new first index to the extracted violation abuse resource if, as a result of the determination, it is determined that the first index has not been assigned to the extracted violation abuse resource.

12. The violation incident management system of claim 11, wherein:
the violation resource management module further comprises a second index determination module configured to determine whether a second index for violation association information matched up with the extracted violation abuse resource is present within a set time if the previous first index has been assigned to the extracted violation abuse resource, and
the second index determination module generates history information about the extracted violation abuse resource if, as a result of the determination, it is determined that the second index for the violation association information is present and assigns a new second index to the violation association information if, as a result of the determination, it is determined that the second index for the violation association information is not present.

13. A non-transitory computer-readable recording medium on which a program for executing a method for managing violation abuse information according to claim 1 has been recorded.
